(19) United States
(12) Patent Application Publication
(10) Pub. No.: US 2023/0096694 A1
(43) Pub. Date: Mar. 30, 2023

(54) IMAGE PROCESSING DEVICE, IMAGE PROCESSING METHOD, AND IMAGE PROCESSING PROGRAM

(71) Applicant: FUJIFILM Corporation, Tokyo (JP)

(72) Inventor: Tomoyuki TAKAHASHI, Kanagawa-ken (JP)

(73) Assignee: FUJIFILM Corporation, Tokyo (JP)

(21) Appl. No.: 17/823,353

(22) Filed: Aug. 30, 2022

(30) Foreign Application Priority Data
Sep. 27, 2021 (JP) 2021-157099

(51) Int. Cl. G06T 5/50; G06V 10/70

(52) U.S. Cl. CPC G06T 5/50; G06V 10/70; G06T 2207/10116; G06T 2207/20081; G06T 2207/20221; G06T 2207/20224; G06T 2207/30008

(57) ABSTRACT

A processor derives a first composition image representing a first composition included in a subject including three or more compositions from at least one radiation image acquired by imaging the subject, derives at least one removal radiation image obtained by removing the first composition from the at least one radiation image by using the first composition image, derives a plurality of other composition images representing a plurality of other compositions different from the first composition included in the subject by using the at least one removal radiation image, and derives a composite image obtained by synthesizing the first composition image and the plurality of other composition images at a predetermined ratio.

### CROSS REFERENCE TO RELATED APPLICATIONS

The present application claims priority under 35 U.S.C. § 119 to Japanese Patent Application No. 2021-157099 filed on Sep. 27, 2021. The above application is hereby expressly incorporated by reference, in its entirety, into the present application.

### BACKGROUND

### Technical Field

The present disclosure relates to an image processing device, an image processing method, and an image processing program.

### Related Art

A composition of fat or a composition of muscle is derived from a soft part image by deriving the soft part image and a bone part image of a subject by energy subtraction processing using two radiation images obtained by irradiating the subject with two types of radiation having different energy distributions (see JP2019-202035A). In addition, an artificial object, such as a gypsum cast, a catheter, glass in a human body, plastic, and a metal, is also extracted by the energy subtraction processing (see JP2009-077839A).

The images of the compositions derived by the energy subtraction processing described above are used appropriately in accordance with the purpose of diagnosis. For example, the soft part image is effective for the purpose of observing a lesion positioned at a position overlapping the ribs in a lung field, and the bone part image is effective for the purpose of finding a minute fracture or the like without being interfered by a soft tissue.

On the other hand, there is also a desire to combine images of the compositions and use the combined images for diagnosis. However, there are some compositions that are difficult to be visually recognized by only superimposing the images of the compositions. For example, since the gauze used for surgery is difficult to be visually recognized in a case of overlapping the bone, an image obtained by extracting the gauze is more easily visually recognized in a case in which the image is combined with the soft part image than a case in which the image is combined with the bone part image.

### SUMMARY OF THE INVENTION

The present disclosure has been made in view of the above circumstances, and is to make it easier to visually recognize a desired composition by using an image of each composition.

An image processing device according to the present disclosure comprises at least one processor, in which the processor derives a first composition image representing a first composition included in a subject including three or more compositions from at least one radiation image acquired by imaging the subject, derives at least one removal radiation image obtained by removing the first composition from the at least one radiation image by using the first composition image, derives a plurality of other composition images representing a plurality of other compositions different from the first composition included in the subject by using the at least one removal radiation image, and derives a composite image obtained by synthesizing the first composition image and the plurality of other composition images at a predetermined ratio.

Note that, in the image processing device according to the present disclosure, the processor may acquire a first radiation image and a second radiation image acquired by imaging the subject with radiation having different energy distributions, and may derive the first composition image by performing weighting subtraction on the first radiation image and the second radiation image.

In addition, in the image processing device according to the present disclosure, the processor may acquire a first radiation image and a second radiation image acquired by imaging the subject with radiation having different energy distributions, and may derive the first composition image from the first radiation image or the second radiation image by using a derivation model that has been subjected to machine learning to derive the first composition image from a radiation image.

In addition, in the image processing device according to the present disclosure, the processor may derive a first removal radiation image and a second removal radiation image obtained by removing the first composition from the first radiation image and the second radiation image by using the first composition image, and may derive the plurality of other composition images by performing weighting subtraction on the first removal radiation image and the second removal radiation image.

In addition, in the image processing device according to the present disclosure, the processor may derive the first composition image from one radiation image by using a first derivation model that has been subjected to machine learning to derive the first composition image from the radiation image, may derive at least one removal radiation image obtained by removing the first composition from the at least one radiation image by using the first composition image, and may derive the plurality of other composition images from one removal radiation image by using a second derivation model that has been subjected to machine learning to derive the plurality of other composition images from the removal radiation image.

In addition, in the image processing device according to the present disclosure, the processor may be able to change the predetermined ratio.

In addition, in the image processing device according to the present disclosure, the first composition may be an artificial object, and the other compositions may be a bone part and a soft part.

In addition, in the image processing device according to the present disclosure, the first composition may be an artificial object, and the other compositions may be a bone part, fat, and muscle.

An image processing method according to the present disclosure comprises deriving a first composition image representing a first composition included in a subject including three or more compositions from at least one radiation image acquired by imaging the subject, deriving at least one removal radiation image obtained by removing the first composition from the at least one radiation image by using the first composition image, deriving a plurality of other composition images representing a plurality of other compositions different from the first composition included in the subject by using the at least one removal radiation image, and deriving a composite image obtained by synthesizing the first composition image and the plurality of other composition images at a predetermined ratio.

Note that a program causing a computer to execute the image processing method according to the present disclosure may be provided.

According to the present disclosure, a desired composition can be easily visually recognized by using an image of each composition.

### BRIEF DESCRIPTION OF THE DRAWINGS

FIG. 1 is a schematic block diagram showing a configuration of a radiography system to which an image processing device according to a first embodiment of the present disclosure is applied.

FIG. 2 is a diagram showing a schematic configuration of the image processing device according to the first embodiment.

FIG. 3 is a diagram showing a functional configuration of the image processing device according to the first embodiment.

FIG. 4 is a diagram showing a first radiation image.

FIG. 5 is a diagram showing an artificial object image.

FIG. 6 is a diagram showing a first removal radiation image.

FIG. 7 is a diagram showing a bone part image.

FIG. 8 is a diagram showing a soft part image.

FIG. 9 is a diagram showing a composite image.

FIG. 10 is a flowchart showing processing performed in the first embodiment.

FIG. 11 is a diagram showing a functional configuration of an image processing device according to a second embodiment.

FIG. 12 is a diagram showing an example of energy spectra of radiation after being transmitted through a muscle tissue and radiation after being transmitted through a fat tissue.

FIG. 13 is a flowchart showing processing performed in the second embodiment.

### DETAILED DESCRIPTION

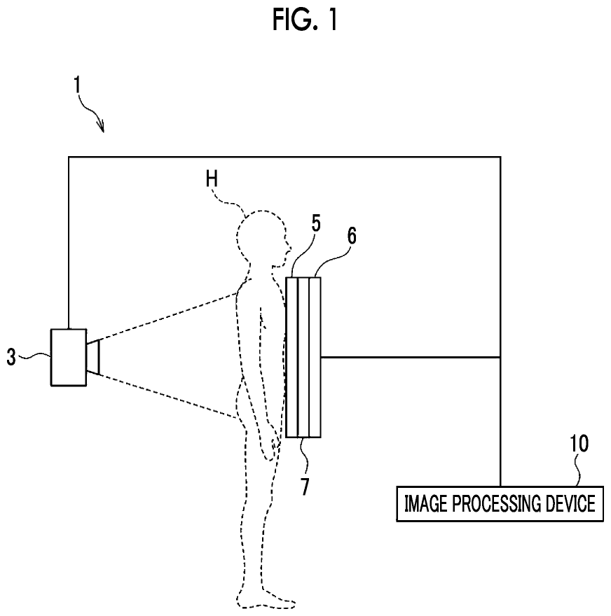

Hereinafter, embodiments of the present disclosure will be described with reference to the drawings. FIG. 1 is a schematic block diagram showing a configuration of a radiography system to which an image processing device according to a first embodiment of the present disclosure is applied. As shown in FIG. 1, the radiography system according to the first embodiment comprises an imaging apparatus 1, and an image processing device 10 according to the first embodiment.

The imaging apparatus 1 is an imaging apparatus that performs energy subtraction by a so-called one-shot method of converting radiation, such as X-rays, emitted from a radiation source 3 and transmitted through a subject H into energy and irradiating a first radiation detector 5 and a second radiation detector 6 with the converted radiation. During imaging, as shown in FIG. 1, the first radiation detector 5, a radiation energy conversion filter 7 consisting of a copper plate or the like, and the second radiation detector 6 are disposed in order from a side closest to the radiation source 3, and the radiation source 3 is driven. Note that the first and second radiation detectors 5 and 6 are closely attached to the radiation energy conversion filter 7.

As a result, in the first radiation detector 5, a first radiation image G1 of the subject H by low-energy radiation including so-called soft rays is acquired. In addition, in the second radiation detector 6, a second radiation image G2 of the subject H by high-energy radiation from which the soft rays are removed is acquired. The first and second radiation images are input to the image processing device 10.

The first and second radiation detectors 5 and 6 can perform recording and reading-out of the radiation image repeatedly. A so-called direct-type radiation detector that directly receives irradiation with the radiation and generates an electric charge may be used, or a so-called indirect-type radiation detector that converts the radiation into visible light and then converts the visible light into an electric charge signal may be used. In addition, as a method of reading out a radiation image signal, it is desirable to use a so-called thin film transistor (TFT) readout method in which the radiation image signal is read out by turning a TFT switch on and off, or a so-called optical readout method in which the radiation image signal is read out by irradiation with read out light. However, other methods may also be used without being limited to these methods.

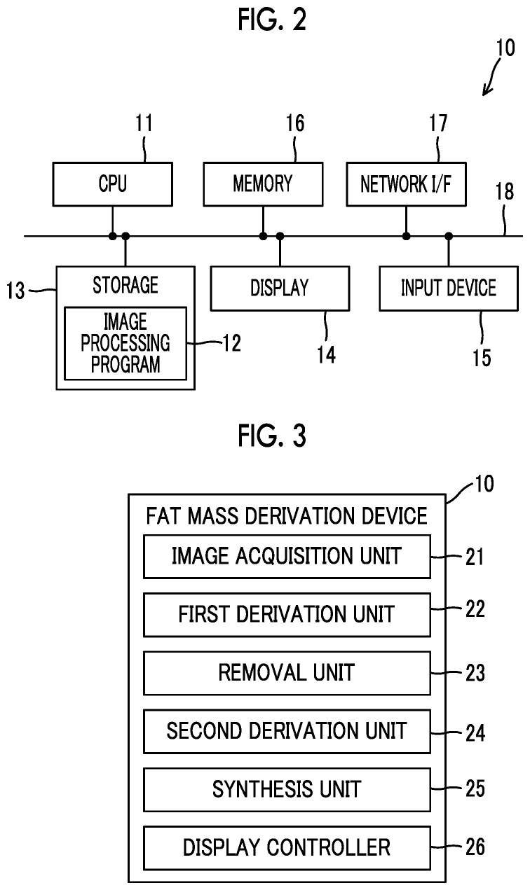

Then, the image processing device according to the first embodiment will be described. First, a hardware configuration of the image processing device according to the first embodiment will be described with reference to FIG. 2. As shown in FIG. 2, the image processing device 10 is a computer, such as a workstation, a server computer, and a personal computer, and comprises a central processing unit (CPU) 11, a non-volatile storage 13, and a memory 16 as a transitory storage region. In addition, the image processing device 10 comprises a display 14, such as a liquid crystal display, an input device 15, such as a keyboard and a mouse, and a network interface (I/F) 17 connected to a network (not shown). The CPU 11, the storage 13, the display 14, the input device 15, the memory 16, and the network I/F 17 are connected to a bus 18. Note that the CPU 11 is an example of a processor according to the present disclosure.

The storage 13 is realized by a hard disk drive (HDD), a solid state drive (SSD), a flash memory, and the like. An image processing program 12 installed in the image processing device 10 is stored in the storage 13 as a storage medium. The CPU 11 reads out the image processing program 12 from the storage 13, expands the read out image processing program 12 to the memory 16, and executes the expanded image processing program 12.

Note that the image processing program 12 is stored in a storage device of the server computer connected to the network or in a network storage in a state of being accessible from the outside, and is downloaded and installed in the computer that configures the image processing device 10 in response to the request. Alternatively, the image processing program 12 is distributed in a state of being recorded on a recording medium, such as a digital versatile disc (DVD) or a compact disc read only memory (CD-ROM), and is installed in the computer that configures the image processing device 10 from the recording medium.

Then, a functional configuration of the image processing device according to the first embodiment will be described. FIG. 3 is a diagram showing the functional configuration of the image processing device according to the first embodiment. As shown in FIG. 3, the image processing device 10 comprises an image acquisition unit 21, a first derivation unit 22, a removal unit 23, a second derivation unit 24, a synthesis unit 25, and a display controller 26. Moreover, by executing the image processing program 12, the CPU 11 functions as the image acquisition unit 21, the first derivation unit 22, the removal unit 23, the second derivation unit 24, the synthesis unit 25, and the display controller 26.

The image acquisition unit 21 acquires, for example, the first radiation image G1 and the second radiation image G2 which are the front images of the periphery of the crotch of the subject H from the first and second radiation detectors 5 and 6 by causing the imaging apparatus 1 to perform energy subtraction imaging of the subject H. In a case in which the first radiation image G1 and the second radiation image G2 are acquired, imaging conditions, such as an imaging dose, a radiation quality, a tube voltage, a source image receptor distance (SID) which is a distance between the radiation source 3 and surfaces of the first and second radiation detectors 5 and 6, a source object distance (SOD) which is a distance between the radiation source 3 and a surface of the subject H, and the presence or absence of a scattered ray removal grid are set.

The SOD and the SID are used to calculate a body thickness distribution as described below. It is preferable that the SOD be acquired by, for example, a time of flight (TOF) camera. It is preferable that the SID be acquired by, for example, a potentiometer, an ultrasound range finder, a laser range finder, or the like.

The imaging conditions need only be set by input from the input device 15 by an operator.

Here, each of the first radiation image G1 and the second radiation image G2 includes a scattered ray component based on the radiation scattered in the subject H in addition to a primary ray component of the radiation transmitted through the subject H. Therefore, the image acquisition unit 21 removes the scattered ray component from the first radiation image G1 and the second radiation image G2. For example, the image acquisition unit 21 may remove the scattered ray component from the first radiation image G1 and the second radiation image G2 by applying a method disclosed in JP2015-043959A. In a case in which a method disclosed in JP2015-043959A or the like is used, the derivation of the body thickness distribution of the subject H and the derivation of the scattered ray component for removing the scattered ray component are performed at the same time. Note that the removal of the scattered ray component may be performed by the first derivation unit 22 described below.

Hereinafter, the removal of the scattered ray component from the first radiation image G1 will be described, but the removal of the scattered ray component from the second radiation image G2 can also be performed in the same manner. First, the image acquisition unit 21 acquires a virtual model of the subject H having an initial body thickness distribution T0(x,y). The virtual model is data virtually representing the subject H of which a body thickness in accordance with the initial body thickness distribution T0(x,y) is associated with a coordinate position of each pixel of the first radiation image G1. Note that the virtual model of the subject H having the initial body thickness distribution T0(x,y) may be stored in the storage 13 of the image processing device 10 in advance. In addition, the image acquisition unit 21 may calculate a body thickness distribution T(x,y) of the subject H based on the SID and the SOD included in the imaging conditions. In this case, the initial body thickness distribution T0(x,y) can be obtained by subtracting the SOD from the SID.

Next, the image acquisition unit 21 generates, based on the virtual model, an image obtained by synthesizing an estimated primary ray image in which a primary ray image obtained by imaging the virtual model is estimated and an estimated scattered ray image in which a scattered ray image obtained by imaging the virtual model is estimated as an estimated image in which the first radiation image G1 obtained by imaging the subject H is estimated.

Next, the image acquisition unit 21 corrects the initial body thickness distribution T0(x,y) of the virtual model such that a difference between the estimated image and the first radiation image G1 is small. The image acquisition unit 21 repeatedly performs the generation of the estimated image and the correction of the body thickness distribution until the difference between the estimated image and the first radiation image G1 satisfies a predetermined termination condition. The image acquisition unit 21 derives the body thickness distribution in a case in which the termination condition is satisfied as the body thickness distribution T(x,y) of the subject H. In addition, the image acquisition unit 21 removes the scattered ray component included in the first radiation image G1 by subtracting the scattered ray component in a case in which the termination condition is satisfied from the first radiation image G1. Note that, in the following description, it is regarded that the scattered ray component is removed from the first radiation image G1 and the second radiation image G2.

The first derivation unit 22 derives an artificial object image Ga that represents a region of an artificial object included in the subject H from the first radiation image G1 or the second radiation image G2 acquired by the image acquisition unit 21. Examples of the artificial object include a metal embedded in the subject H, such as a screw for connecting bones, a catheter inserted into the subject H, a surgical tool, such as gauze forgotten in the body after surgery, and a cast attached to the outside of the subject H. In the present embodiment, the artificial object image Ga representing the metal, such as the screw, attached to a vertebra of the subject H in order to fix the vertebra is derived.

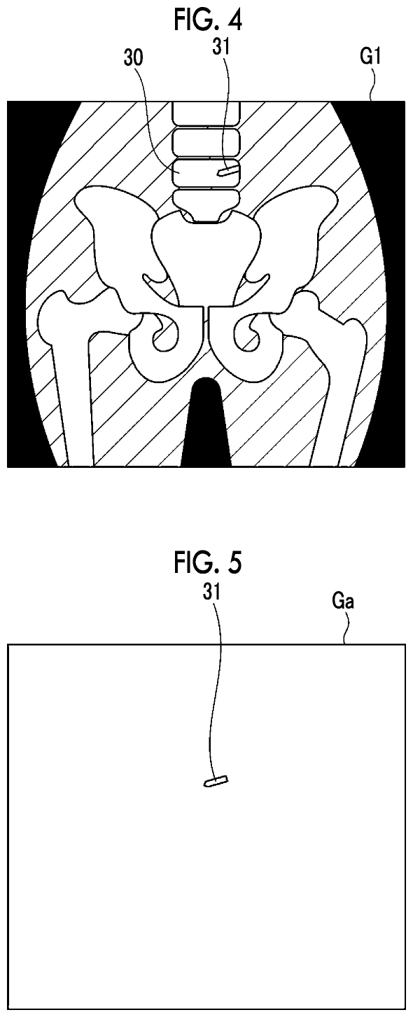

FIG. 4 is a diagram showing the first radiation image G1. As shown in FIG. 4, in the first radiation image G1, a metal screw 31 is attached to a second lumbar vertebra 30. Note that, since the metal does not easily transmit the radiation, it appears as overexposure, that is, a region in which a brightness value is saturated in the first and second radiation images G1 and G2.

Therefore, the first derivation unit 22 detects a region in which the brightness value is saturated in the first radiation image G1 or the second radiation image G2 as an artificial object region. In the present embodiment, it is regarded that the artificial object region is detected in the first radiation image G1. Moreover, the first derivation unit 22 removes the detected artificial object region from the first radiation image G1, interpolates the removed artificial object region by the pixel values of the surrounding regions, and derives a first interpolated radiation image Gh1. Moreover, the first derivation unit 22 derives the artificial object image Ga obtained by extracting only the artificial object included in the first radiation image G1 by deriving a difference between the corresponding pixels of the first radiation image G1 and the first interpolated radiation image Gh1. FIG. 5 is a diagram showing the artificial object image. As shown in FIG. 5, the artificial object image Ga is an image including only the screw 31 which is the artificial object included in the subject H. The artificial object image Ga is an example of a first composition image.

Note that, it is also possible to extract the artificial object region by using an absorption difference of different radiation energies by the artificial object. In this case, the first derivation unit 22 derives reaching doses IH_0 and IL_0 of the radiation in a direct radiation region (that is, a region irradiated with the radiation without being transmitted through the subject H by the radiation detectors 5 and 6) in the first radiation image G1 and the second radiation image G2. In addition, the reaching doses IH_h and IL_h of the radiation in the subject region in the first radiation image G1 and the second radiation image G2 are derived.

Moreover, the first derivation unit 22 derives a radiation absorption amount CH by the subject H obtained from the first radiation image G1 by CH=IH_0−IH_h, and derives a radiation absorption amount CL by the subject H obtained from the second radiation image G2 by CL=IL_0−IL_h. Note that, for the reaching dose, the pixel values of the first and second radiation images G1 and G2 are used.

Here, a ratio CL/CH of the radiation absorption amount between the second radiation image G2 and the first radiation image G1 is larger in the metal than in the tissue of the human body. Therefore, the first derivation unit 22 extracts, as the artificial object region, a region in the first radiation image G1 or the second radiation image G2 in which the ratio CL/CH of the radiation absorption amount is larger than a predetermined threshold value Th1. Note that the threshold value Th1 may be a fixed value, or may be determined in accordance with imaging conditions or the body thickness of the subject H. In this case, a ratio of the radiation absorption amount of the artificial object and a ratio of the radiation absorption rate of the bone part may be derived in advance in accordance with the body thickness, and an intermediate value thereof may be used as the threshold value Th1.

Moreover, the first derivation unit 22 derives the artificial object image Ga obtained by extracting only the artificial object included in the first radiation image G1 by deriving a difference between the corresponding pixels of the first radiation image G1 and the first interpolated radiation image Gh1.

Note that the first derivation unit 22 may derive the artificial object image Ga from the first radiation image G1 or the second radiation image G2 by using a derivation model that has been subjected to machine learning to derive the artificial object image Ga from the radiation image. In particular, since many artificial objects in the subject H have a specific shape, the artificial object image Ga can be derived from the first radiation image G1 or the second radiation image G2 by constructing the derivation model to extract a specific shaped region. For example, surgical gauze is woven with radiation absorption threads impregnated with a contrast medium, and in a case in which the surgical gauze is present in the body, the radiation absorption threads are included in the radiation image of the subject while having a characteristic shape. Therefore, by constructing the derivation model to extract the characteristic shape of the radiation absorption threads, it is possible to derive the artificial object image Ga representing the gauze from the radiation image.

In addition, the first derivation unit 22 may derive the artificial object image Ga obtained by extracting only the artificial object included in the first radiation image G1 and the second radiation image G2 by performing weighting subtraction between the corresponding pixels, on the first radiation image G1 and the second radiation image G2 as shown in Expression (1). Note that, in Expression (1), μa is a weighting coefficient, which is derived in accordance with a radiation attenuation coefficient of the metal in accordance with the radiation energy.

(x,y) are coordinates of each pixel of each image.

Ga(x,y)=G1(x,y)−μa×G2(x,y) (1)

The removal unit 23 derives a first removal radiation image Gr1 and a second removal radiation image Gr2 by removing the artificial object region from each of the first and second radiation images G1 and G2. Specifically, as shown in Expressions (2) and (3), the first removal radiation image Gr1 and the second removal radiation image Gr2 obtained by removing the artificial object region from the first radiation image G1 and the second radiation image G2 is derived by performing the weighting subtraction between the corresponding pixels, on the first and second radiation images G1 and G2, and the artificial object image Ga. Note that α1(x,y) and α2(x,y) are the weighting coefficients, and are set to values at which the artificial object region can be removed from the first radiation image G1 and the second radiation image G2. In addition, the weighting coefficient is set to 0 in a region outside the artificial object region.

Gr1(x,y)=G1(x,y)−α1(x,y)×Ga(x,y) (2)

Gr2(x,y)=G2(x,y)−α2(x,y)×Ga(x,y) (3)

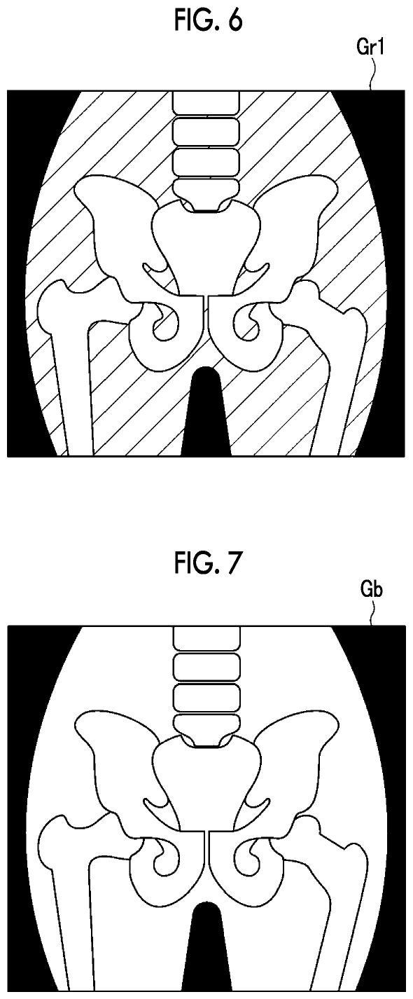

FIG. 6 is a diagram showing the first removal radiation image Gr1. As shown in FIG. 6, in the first removal radiation image Gr1, the artificial object region is removed. Note that the removal unit 23 similarly removes the artificial object region from the second radiation image G2 to derive the second removal radiation image Gr2.

The second derivation unit 24 derives a bone part image Gb obtained by extracting only the bone part of the subject H included in the first radiation image G1 and the second radiation image G2 and a soft part image Gs obtained by extracting only the soft part by performing the weighting subtraction between the corresponding pixels, on the first removal radiation image Gr1 and the second removal radiation image Gr2, as shown in Expressions (4) and (5). Note that μb and μs in Expressions (4) and (5) are the weighting coefficients, and are derived in accordance with the radiation attenuation coefficient of the bone part and the soft part in accordance with the radiation energy.

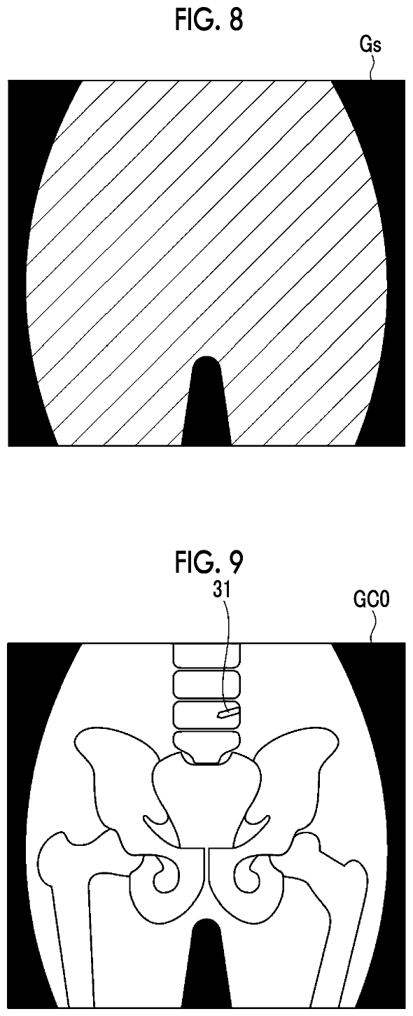

(x,y) are coordinates of each pixel of each image. FIG. 7 is a diagram showing the bone part image Gb, and FIG. 8 is a diagram showing the soft part image Gs. Note that the bone part image Gb and the soft part image Gs are examples of other composition images.

Gb(x,y)=Gr1(x,y)−μb×Gr2(x,y) (4)

Gs(x,y)=Gr1(x,y)−μs×Gr2(x,y) (5)

Note that the second derivation unit 24 may derive the bone part image Gb and the soft part image Gs from the first removal radiation image Gr1 and the second removal radiation image Gr2 by using a derivation model that has been subjected to machine learning to derive the bone part image Gb and the soft part image Gs from the first removal radiation image Gr1 and the second removal radiation image Gr2. In this case, the derivation model that derives the bone part image Gb and the soft part image Gs from the first removal radiation image Gr1 and the second removal radiation image Gr2 can be constructed by training a neural network using teacher data including the first and second radiation images G1 and G2 that do not include the artificial object acquired by the energy subtraction imaging, and the bone part image and the soft part image derived from the first and second radiation images G1 and G2 that do not include the artificial object by the energy subtraction processing.

The synthesis unit 25 derives a composite image GC0 obtained by synthesizing the artificial object image Ga, the bone part image Gb, and the soft part image Gs at a predetermined ratio. In the present embodiment, the predetermined ratio can be changed in accordance with the purpose of imaging in accordance with an imaging site. For example, in an orthopedic system, in some cases, it is observed whether or not a fixing tool is loose after performing surgery of fixing the bone, such as a thoracic vertebra, a lumbar vertebra, and a femur. For such a purpose of imaging, the synthesis unit 25 derives the composite image GC0 by adding the artificial object image Ga, the bone part image Gb, and the soft part image Gs at a ratio of artificial object image Ga:bone part image Gb:soft part image Gs=100%:100%:0% such that the soft part does not interfere with the fixing tool. In this case, as shown in Expression (6), the composite image GC0 is derived by performing weighting addition between the pixels of the artificial object image Ga, the bone part image Gb, and the soft part image Gs. FIG. 9 is a diagram showing an example of the composite image GCO. As shown in FIG. 9, the composite image GC0 is an image that does not include the soft tissue but includes a bone tissue and the screw 31 which is the artificial object.

GC0(x,y)=1×Ga(x,y)+1×Gb(x,y)+0×Gs(x,y) (6)

Note that, by lowering a synthesis ratio of the artificial object image Ga, it is possible to reduce the glare of the composite image GC0 caused by the overexposure of the artificial object region, particularly in a case in which the artificial object is a metal. In this case, the synthesis unit 25 need only derive the composite image GC0 by adding the artificial object image Ga, the bone part image Gb, and the soft part image Gs at a ratio of artificial object image Ga:bone part image Gb:soft part image Gs=20%:100%:0%. Note that, in this case, it is preferable that the synthesis ratio can be changed by using the input device 15.

In addition, after performing surgery of abdomen, in some cases, it is confirmed whether or not a surgical tool, such as gauze used in the surgery, remains in the body. In such a case, in order to prevent the surgical tool from being difficult to see due to the bone part, the synthesis unit 25 derives the composite image GC0 by adding the artificial object image Ga, the bone part image Gb, and the soft part image Gs at a ratio of artificial object image Ga:bone part image Gb:soft part image Gs=100%:0%:100%. In addition, in order to make it easier to see the surgical tool while grasping a positional relationship of the bones, the composite image GC0 may be derived at a ratio of artificial object image Ga:bone part image Gb:soft part image Gs=100%:20%:100%. Further, in order to enhance the surgical tool, the synthesis ratio of the bone part image Gb and the soft part image Gs may be relatively low with respect to the artificial object image Ga. For example, the composite image GC0 may be derived at a ratio of artificial object image Ga:bone part image Gb:soft part image Gs=100%:10%:50%. In this case, as shown in Expression (7), the composite image GC0 is derived by performing the weighting addition between the pixels of the artificial object image Ga, the bone part image Gb, and the soft part image Gs.

GC0(x,y)=1×Ga(x,y)+0.1×Gb(x,y)+0.5×Gs(x,y) (7)

In addition, in some cases, a lesion, such as a mass in a lung field, is observed for the subject in which the artificial object is embedded. In this case, the lesion can be more easily observed by using only the soft part image Gs that does not include the bone part and the artificial object. Therefore, the synthesis unit 25 derives the composite image GC0 at a ratio of artificial object image Ga:bone part image Gb:soft part image Gs=0%:0%:100%. Note that the bone part image Gb may be included to the extent that it does not interfere with the interpretation of the lesion such that a positional relationship between the lesion and the bone can be grasped. In this case, the synthesis unit 25 need only derive the composite image GC0 at a ratio of artificial object image Ga:bone part image Gb:soft part image Gs=0%:20%:100%.

In addition, in some cases, it is confirmed whether or not the catheter inserted into the trachea is at a correct position in the trachea. In such a case, in order to prevent the catheter from being difficult to see due to the bone part, the synthesis unit 25 derives the composite image GC0 at a ratio of artificial object image Ga:bone part image Gb:soft part image Gs=100%:0%:100%. In addition, in order to make it easier to see the catheter while grasping a positional relationship of the bones, the composite image GC0 may be derived at a ratio of artificial object image Ga:bone part image Gb:soft part image Gs=100%:20%:100%.

The display controller 26 displays the composite image GC0 on the display 14.

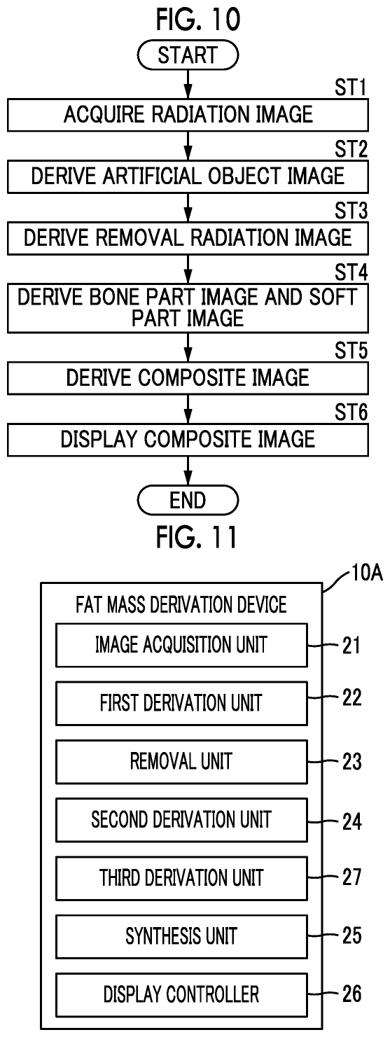

Then, processing performed in the first embodiment will be described. FIG. 10 is a flowchart showing the processing performed in the first embodiment. First, the image acquisition unit 21 causes the imaging apparatus 1 to perform imaging to acquire the first and second radiation images G1 and G2 having different energy distributions from each other (step ST1). Then, the first derivation unit 22 derives the artificial object image Ga representing the region of the artificial object included in the subject H from the first radiation image G1 or the second radiation image G2 (step ST2). Moreover, the removal unit 23 derives the first removal radiation image Gr1 and the second removal radiation image Gr2 by removing the artificial object region from each of the first and second radiation images G1 and G2 (removal radiation image derivation; step ST3).

Subsequently, the second derivation unit 24 derives the bone part image Gb obtained by extracting only the bone part of the subject H included in the first radiation image G1 and the second radiation image G2 and the soft part image Gs obtained by extracting only the soft part by performing the weighting subtraction between the corresponding pixels, on the first removal radiation image Gr1 and the second removal radiation image Gr2 (step ST4). Then, the synthesis unit 25 derives the composite image GC0 obtained by synthesizing the artificial object image Ga, the bone part image Gb, and the soft part image Gs at the predetermined ratio (step ST5). Moreover, the display controller 26 displays the composite image GC0 on the display 14 (step ST6), and the processing is terminated.

As described above, in the first embodiment, since the composite image GC0 is derived by synthesizing the images of the compositions at the predetermined ratio, it can be easily visually recognize a desired composition in the composite image GC0.

Then, a second embodiment of the present disclosure will be described. FIG. 11 is a functional configuration of an image processing device according to the second embodiment of the present disclosure. Note that, in FIG. 11, the same reference numerals are assigned to the same configurations as those in FIG. 3, and the detailed description thereof will be omitted. An image processing device 10A according to the second embodiment is different from that of the first embodiment in that a third derivation unit 27 that derives a fat image and a muscle image from the soft part image Gs is provided.

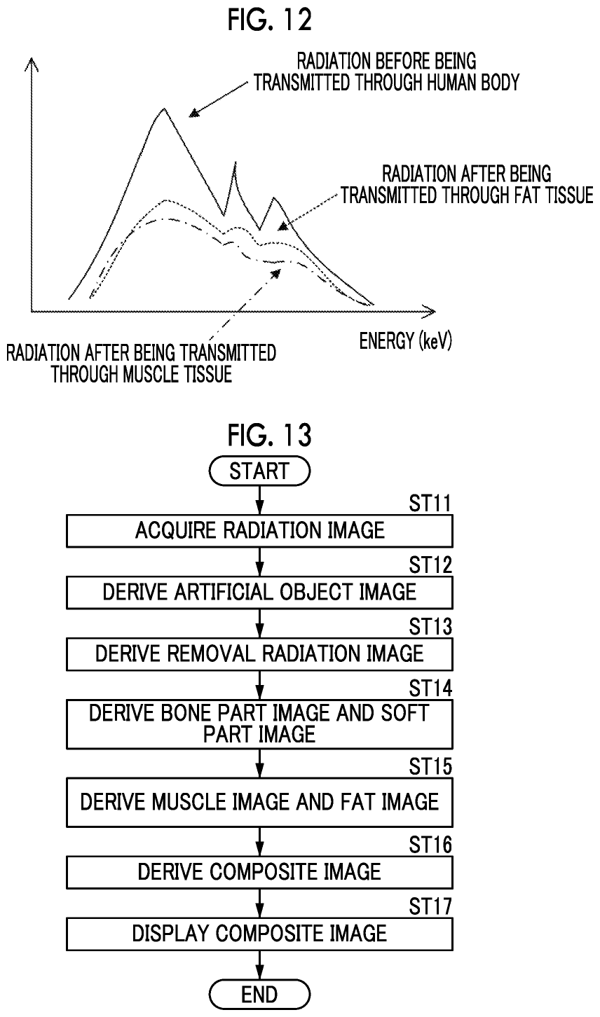

The third derivation unit 27 separates a muscle tissue and a fat tissue in the soft tissue of the subject H by using a difference in the energy characteristics of the muscle tissue and the fat tissue, and derives a muscle image Gm and a fat image Gf. As shown in FIG. 12, the dose of the radiation after being transmitted through the subject H, which is the human body, is lower than the dose of the radiation before being incident on the subject H. In addition, since the energy absorbed by the muscle tissue and the energy absorbed by the fat tissue is different and attenuation coefficients are different, the energy spectra of the radiation after being transmitted through the muscle tissue and the radiation after being transmitted through the fat tissue in the radiation after being transmitted through the subject H are different. As shown in FIG. 12, the energy spectrum of the radiation transmitted through the subject H and emitted to each of the first radiation detector 5 and the second radiation detector 6 depends on a body composition of the subject H, specifically, a ratio between the muscle tissue and the fat tissue. Since the fat tissue is more likely to transmit the radiation than the muscle tissue, the dose of the radiation after being transmitted through the human body is smaller in a case in which the ratio of the muscle tissue is larger than the ratio of the fat tissue.

Therefore, the third derivation unit 27 separates the muscle tissue and the fat tissue from the soft part image Gs by using the difference in the energy characteristics of the muscle tissue and the fat tissue described above, and derives the muscle image and the fat image from the soft part image Gs.

Note that a specific method by which the third derivation unit 27 separates muscle and fat from the soft part image Gs is not limited, but as an example, the third derivation unit 27 according to the present embodiment derives the muscle image from the soft part image Gs by Expression (8) and Expression (9). Specifically, first, the third derivation unit 27 derives a muscle percentage rm(x,y) at each pixel position (x,y) in the soft part image Gs by Expression (8). Note that, in Expression (8), μm is the weighting coefficient in accordance with the attenuation coefficient of the muscle tissue, and μf is the weighting coefficient in accordance with the attenuation coefficient of the fat tissue. T(x,y) is the body thickness of the subject H derived in a case in which the scattered ray component described above is removed. In addition, Δ(x,y) represents a concentration difference distribution. The concentration difference distribution is a distribution of a concentration change on the image, which is seen from a concentration obtained by making the radiation reach the first radiation detector 5 and the second radiation detector 6 without being transmitted through the subject H. The distribution of the concentration change on the image is calculated by subtracting the concentration of each pixel in the region of the subject H from the concentration of the direct radiation region in the soft part image Gs.

rm(x,y)={μf−Δ(x,y)/T(x,y)}/(μf−μm) (8)

Moreover, the third derivation unit 27 derives the muscle image Gm from the soft part image Gs by Expression (9). Note that x and y in Expression (9) are coordinates of each pixel of the muscle image Gm.

Gm(x,y)=rm(x,y)×Gs(x,y) (9)

Further, the third derivation unit 27 derives the fat image Gf from the soft part image Gs and the muscle image Gm by Expression (10). Note that x and y in Expression (10) are coordinates of each pixel of the fat image Gf.

Gf(x,y)=Gs(x,y)−Gm(x,y) (10)

Note that the second radiation image G2 may derive the muscle image Gm and the fat image Gf from the soft part image Gs by using a derivation model that has been subjected to machine learning to derive the muscle image Gm and the fat image Gf from the soft part image Gs. In this case, the derivation model that derives the muscle image Gm and the fat image Gf from the soft part image Gs can be constructed by training the neural network using teacher data including the soft part image Gs derived from the first and second radiation images G1 and G2 that do not include the artificial object acquired by the energy subtraction imaging, and the muscle image Gm and the fat image Gf derived from the soft part image Gs as described above.

In the second embodiment, the synthesis unit 25 derives the composite image GC0 obtained by synthesizing the artificial object image Ga, the bone part image Gb, the muscle image Gm, and the fat image Gf at the predetermined ratio. Note that the composite image GC0 obtained by synthesizing the muscle image Gm and the fat image Gf at a ratio of 100%:100% is the soft part image Gs. Therefore, in the second embodiment, the synthesis unit 25 excludes the soft part image Gs from a target of synthesizing.

Also in the second embodiment, the predetermined ratio need only be set in accordance with the purpose of imaging. For example, in a case of observing fat mass or muscle mass of the abdomen, the artificial object and the bone part interfere with the observation. In a case of observing the fat mass, the synthesis unit 25 need only derive the composite image GC0 by adding the artificial object image Ga, the bone part image Gb, the muscle image Gm, and the fat image Gf at a ratio of artificial object image Ga:bone part image Gb:muscle image Gm:the fat image Gf=0%:0%:0%:100%.

In addition, in a case of observing the muscle mass, the synthesis unit 25 need only derive the composite image GC0 at a ratio of artificial object image Ga:bone part image Gb:muscle image Gm:fat image Gf=0%:0%:100%:0%. In addition, in a case of observing the fat mass, in order to grasp a positional relationship with the bone and the organ (mainly muscle), the composite image GC0 may be derived at a ratio of artificial object image Ga:bone part image Gb:muscle image Gm:fat image Gf=0%:10%:20%:100%.

In addition, in some cases, muscle that supports the bone is evaluated. For example, in a case in which muscle around the hip joint is well developed, dislocation of the hip joint is unlikely to occur, and thus muscle around the hip joint is evaluated in some cases. In this case, the synthesis unit 25 need only derive the composite image GC0 at a ratio of artificial object image Ga:bone part image Gb:muscle image Gm:fat image Gf=0%:100%:100%:0%. Note that, in this case, the muscle tissue can be easily seen by lowering the synthesis ratio of the bone part image Gb. In this case, the synthesis unit 25 need only derive the composite image GC0 at a ratio of artificial object image Ga:bone part image Gb:muscle image Gm:fat image Gf=0%:50%:100%:0%.

In addition, as the bone density is decreased with aging, the contrast of the muscle is relatively larger than that of the bone. Therefore, it is preferable to suppress the contrast of the muscle such that both the bone and the muscle can be easily seen. In this case, the synthesis unit 25 need only derive the composite image GC0 at a ratio of artificial object image Ga:bone part image Gb:muscle image Gm:fat image Gf=0%:100%:50%:0%.

Then, processing performed in the second embodiment will be described. FIG. 13 is a flowchart showing the processing performed in the second embodiment. First, the image acquisition unit 21 causes the imaging apparatus 1 to perform imaging to acquire the first and second radiation images G1 and G2 having different energy distributions from each other (step ST11). Then, the first derivation unit 22 derives the artificial object image Ga representing the region of the artificial object included in the subject H from the first radiation image G1 or the second radiation image G2 (step ST12). Moreover, the removal unit 23 derives the first removal radiation image Gr1 and the second removal radiation image Gr2 by removing the artificial object region from each of the first and second radiation images G1 and G2 (derive the removal radiation image; step ST13).

Subsequently, the second derivation unit 24 derives the bone part image Gb obtained by extracting only the bone part of the subject H included in the first radiation image G1 and the second radiation image G2 and the soft part image Gs obtained by extracting only the soft part by performing the weighting subtraction between the corresponding pixels, on the first removal radiation image Gr1 and the second removal radiation image Gr2 (step ST14). Further, the third derivation unit 27 derives the muscle image Gm and the fat image Gf from the soft part image Gs (step ST15). Then, the synthesis unit 25 derives the composite image GC0 obtained by synthesizing the artificial object image Ga, the bone part image Gb, the muscle image Gm, and the fat image Gf at the predetermined ratio (step ST16). Moreover, the display controller 26 displays the composite image GC0 on the display 14 (step ST17), and the processing is terminated.

Note that, in each of the embodiments described above, in some cases, the artificial object image Ga, the bone part image Gb, the soft part image Gs, the muscle image Gm, and the fat image Gf are derived by using the derivation model. In this case, only one radiation image may be acquired by imaging. As only one radiation image, it is preferable to use the radiation image acquired from the radiation detector 5 in the imaging apparatus 1 shown in FIG. 1 on the side close to the subject H.

In addition, in each of the embodiments described above, the first and second radiation images G1 and G2 are acquired by the one-shot method in a case in which the energy subtraction processing is performed, but the present disclosure is not limited to this. The first and second radiation images G1 and G2 may be acquired by a so-called two-shot method in which imaging is performed twice by using only one radiation detector. In a case of the two-shot method, there is a possibility that a position of the subject H included in the first radiation image G1 and the second radiation image G2 shifts due to a body movement of the subject H. Therefore, in the first radiation image G1 and the second radiation image G2, it is preferable to perform the processing according to the present embodiment after registration of the subject is performed.

In addition, in each of the embodiments described above, the visceral fat mass distribution is derived by using the first and second radiation images acquired by the system that images the subject H by using the first and second radiation detectors 5 and 6, but the visceral fat mass distribution may be derived from the first and second radiation images G1 and G2 acquired by using an accumulative phosphor sheet instead of the radiation detector. In this case, the first and second radiation images G1 and G2 need only be acquired by stacking two accumulative phosphor sheets, emitting the radiation transmitted through the subject H, accumulating and recording radiation image information of the subject H in each of the accumulative phosphor sheets, and photoelectrically reading the radiation image information from each of the accumulative phosphor sheets. Note that the two-shot method may also be used in a case in which the first and second radiation images G1 and G2 are acquired by using the accumulative phosphor sheet.

In addition, the radiation in each of the embodiments described above is not particularly limited, and α-rays or γ-rays can be used in addition to X-rays.

In addition, in each of the embodiments described above, various processors shown below can be used as the hardware structure of processing units that execute various pieces of processing, such as the image acquisition unit 21, the first derivation unit 22, the removal unit 23, the second derivation unit 24, the synthesis unit 25, the display controller 26, and the third derivation unit 27. As described above, the various processors include, in addition to the CPU that is a general-purpose processor which executes software (program) and functions as various processing units, a programmable logic device (PLD) that is a processor whose circuit configuration can be changed after manufacture, such as a field programmable gate array (FPGA), and a dedicated electric circuit that is a processor having a circuit configuration which is designed for exclusive use in order to execute a specific processing, such as an application specific integrated circuit (ASIC).

One processing unit may be configured by one of these various processors, or may be configured by a combination of two or more processors of the same type or different types (for example, a combination of a plurality of FPGAs or a combination of the CPU and the FPGA). In addition, a plurality of the processing units may be configured by one processor.

As an example of configuring the plurality of processing units by one processor, first, as represented by a computer, such as a client and a server, there is an aspect in which one processor is configured by a combination of one or more CPUs and software and this processor functions as a plurality of processing units. Second, as represented by a system on chip (SoC) or the like, there is an aspect of using a processor that realizes the function of the entire system including the plurality of processing units by one integrated circuit (IC) chip. In this way, as the hardware structure, the various processing units are configured by using one or more of the various processors described above.

Moreover, as the hardware structure of these various processors, more specifically, it is possible to use an electrical circuit (circuitry) in which circuit elements, such as semiconductor elements, are combined.

What is claimed is:

1. An image processing device comprising:
at least one processor,
wherein the processor
derives a first composition image representing a first composition included in a subject including three or more compositions from at least one radiation image acquired by imaging the subject,
derives at least one removal radiation image obtained by removing the first composition from the at least one radiation image by using the first composition image,
derives a plurality of other composition images representing a plurality of other compositions different from the first composition included in the subject by using the at least one removal radiation image, and
derives a composite image obtained by synthesizing the first composition image and the plurality of other composition images at a predetermined ratio.

2. The image processing device according to claim 1,
wherein the processor
acquires a first radiation image and a second radiation image acquired by imaging the subject with radiation having different energy distributions, and
derives the first composition image by performing weighting subtraction on the first radiation image and the second radiation image.

3. The image processing device according to claim 1,
wherein the processor
acquires a first radiation image and a second radiation image acquired by imaging the subject with radiation having different energy distributions, and
derives the first composition image from the first radiation image or the second radiation image by using a derivation model that has been subjected to machine learning to derive the first composition image from a radiation image.

4. The image processing device according to claim 2,
wherein the processor
derives a first removal radiation image and a second removal radiation image obtained by removing the first composition from the first radiation image and the second radiation image by using the first composition image, and
derives the plurality of other composition images by performing weighting subtraction on the first removal radiation image and the second removal radiation image.

5. The image processing device according to claim 1,
wherein the processor
derives the first composition image from one radiation image by using a first derivation model that has been subjected to machine learning to derive the first composition image from the radiation image,
derives at least one removal radiation image obtained by removing the first composition from the at least one radiation image by using the first composition image, and
derives the plurality of other composition images from one removal radiation image by using a second derivation model that has been subjected to machine learning to derive the plurality of other composition images from the removal radiation image.

6. The image processing device according to claim 1,
wherein the processor is able to change the predetermined ratio.

7. The image processing device according to claim 1,
wherein the first composition is an artificial object, and
the other compositions are a bone part and a soft part.

8. The image processing device according to claim 1,
wherein the first composition is an artificial object, and
the other compositions are a bone part, fat, and muscle.

9. An image processing method comprising:
deriving a first composition image representing a first composition included in a subject including three or more compositions from at least one radiation image acquired by imaging the subject;
deriving at least one removal radiation image obtained by removing the first composition from the at least one radiation image by using the first composition image;
deriving a plurality of other composition images representing a plurality of other compositions different from the first composition included in the subject by using the at least one removal radiation image; and
deriving a composite image obtained by synthesizing the first composition image and the plurality of other composition images at a predetermined ratio.

10. A non-transitory computer-readable storage medium that stores an image processing program causing a computer to execute:
a procedure of deriving a first composition image representing a first composition included in a subject including three or more compositions from at least one radiation image acquired by imaging the subject;
a procedure of deriving at least one removal radiation image obtained by removing the first composition from the at least one radiation image by using the first composition image;
a procedure of deriving a plurality of other composition images representing a plurality of other compositions different from the first composition included in the subject by using the at least one removal radiation image; and
a procedure of deriving a composite image obtained by synthesizing the first composition image and the plurality of other composition images at a predetermined ratio.
